(19) United States
(12) Patent Application Publication
(10) Pub. No.: US 2012/0180911 A1
(43) Pub. Date: Jul. 19, 2012

(54) METHOD FOR PRODUCING A HOLE IN PLATE MEMBER

(76) Inventors: Mark Bartolomucci, Deckerville, MI (US); James M. Kuriluk, Algonac, MI (US)

(21) Appl. No.: 12/245,192

(22) Filed: Oct. 3, 2008

(51) Int. Cl. B26F 1/02; C21D 1/32; C21D 1/26; B23P 15/00; C21D 1/25

(52) U.S. Cl. 148/624; 83/55; 83/14; 83/50; 148/648

(57) ABSTRACT

The present invention is premised upon a method of piercing a hole through a plate member by removing at least 10% of the hole offal material prior to piercing the hole. In the case of high strength steel plating (e.g. armor plating), the step of annealing before punching may be included, as well as the step of hardening the steel after the punching operation.

### FIELD OF THE INVENTION

The present invention relates to a method of removing material from thick plate materials, more particularly to a method of piercing acutely angled through holes in high strength steel plates.

### BACKGROUND

Efforts to improve the removal of material (e.g. creating through holes of differing configurations) from relatively thick plate material (e.g. greater than about 5 mm thick) cleanly (e.g. little or no burring and/or deformation), efficiently and while maintaining good material properties has been the subject of many different technological advances over time. Of particular interest is the manufacture of thick high strength steel plates with a plurality of holes therein (e.g. a pattern of multiple holes) for use as armor plating in military vehicles. In this application, the holes generally are disposed though the plating at an acute angle relative to the face of the plating. The method used in the creation of the holes should not detract from the performance of the armor plating.

Some of the most well known techniques for creating through holes in plate material include machining (e.g. milling and/or drilling) and punching (e.g. die and button). In the case of machining, cycle time to create the holes may be problematic, especially where the holes are not round in shape. In the case of punching, the amount of pressure required to punch the hole may be excessive. Also, the ability for a punching process alone to create clean holes and without degrading the material properties of the plate material may be problematic.

Newer techniques have also been developed for creating through holes in plate material. For example, high pressure water-jet cutting techniques have been developed as well laser cutting techniques. These can address a number of the issues discussed above, but these techniques tend to be cost prohibitive (e.g. high capital investment and slow cycle times). Another technique, as illustrated in U.S. Pat. No. 5,007,326, teaches the use of casting technology to form the through holes while casting the entire plate. This technique has relatively long cycle times as well as material brittleness issues inherent to casting.

Among the literature that may pertain to this technology include the following patent documents: US905766; U.S. Pat. No. 3,477,317; U.S. Pat. No. 4,477,537; U.S. Pat. No. 4,495,699; U.S. Pat. No. 4,857,119; U.S. Pat. No. 5,007,326; U.S. Pat. No. 5,014,593; U.S. Pat. No. 5,749,140; U.S. Pat. No. 6,892,623; U.S. Pat. No. 6,962,102; U.S. Pat. No. 6,981,327; U.S. Pat. No. 7,225,717; U.S. Pat. No. 7,357,060; WO2005088233A1; EP0403519A4; EP0731332B1; EP1060873A2; and EP1705452A1, all incorporated herein by reference for all purposes.

The present invention seeks to help resolve one or more of the issues discussed above in a new and innovative way.

### SUMMARY OF THE INVENTION

The present invention is directed to a solution to at least one or more of the issues described above. Principally, the present invention seeks to provide a new and innovative technique of manufacturing holes in plate material. More particularly, but not limited to, the present invention teaches a method of manufacturing high strength steel armor plating with a new and innovative method of producing a single or plurality of through holes at an acute angle to the face of the plating.

Accordingly, pursuant to a first aspect of the present invention, there is contemplated a method of piercing a hole through a plate member, comprising the steps of: providing the plate member; removing at least 10% of a hole offal material of the plate member in at least one edge portion of the hole; providing a punch which has a outer cutting surface with a punch profile equivalent to profile of the hole; providing a die which has an open inner surface with a die inner surface profile at least 1% greater than the punch profile; providing a press that holds and moves the punch, the die, or both in an opening and closing motion; closing the press so that the outer cutting surface of the punch at least partially engages the plate member where the at least 10% hole offal material has been removed; closing the press further so that the punch passes through the material of the plate member and at least partially into the die, piercing the hole; and opening the press to that punch retracts from the die and the material.

Accordingly, pursuant to a second aspect of the present invention, there is contemplated a method of piercing a slotted hole at an acute angle through a plate member, comprising the steps of: providing the plate member; machining an angled through hole through the plate member at each end of the slotted hole; providing a punch which has a outer cutting surface with a punch profile equivalent to profile of the slotted hole; providing a die which has an open inner surface with a die profile at least 1% greater than the punch profile; providing a press that holds and moves the punch, the die, or both in an opening an closing motion; providing a jig that holds the plate member at the acute angle of the slotted hole; loading the plate member into the press, on to the jig; closing the press so that the outer cutting surface of the punch at least partially engages the plate member at the angled through holes; closing the press further so that the punch passes through the plate member and at least partially into the die, piercing the slotted hole; and opening the press to that punch retracts from the die and the plate member.

The invention of the first or second aspect may be further characterized by one or any combination of the features described herein, such as the acute angle is between 20 and 30 degrees from vertical relative to a planer surface of the plate member; the plate member is comprised of a steel with a thickness of between 5 mm and 25 mm; including the step of softening the steel to a Brinell hardness below 210 prior to the closing steps; including the step of hardening the steel to a Brinell above about 325 or more after the slotted hole is formed; the softening step includes annealing the steel by heating; the hardening step includes heat treating the plate member with a oil quench method, water quench method, or both; including the step of re-punching the slotted hole with at least a 5% larger punch and 5% larger die; the steel comprises at least 0.6% Cr, 0.6% Mo, 0.15% C, 0.2% Mn, 0.05% Si, and at most 0.05% P, 0.06% S, all by weight.

Accordingly, pursuant to a third aspect of the present invention, there is contemplated a method of piercing an armor steel plate member with a plurality of 20 to 30 degree from vertical slotted holes, comprising the steps of: providing the armor steel plate member; annealing the armor steel plate member by application of heat until a Brinell of less than 210 is achieved; machining a plurality of through holes at 20 to 30 degree from vertical the through the armor steel plate member at each end of the slotted hole; providing a plurality of punches which has a outer cutting surface with a punch profile equivalent to profile of the slotted hole; providing a plurality of dies which has an open inner surface with a die profile at least 1% greater than the punch profile; providing a press that holds and moves the punch, the die, or both in an opening an closing motion; providing a jig that holds the armor steel plate member at the 20 to 30 degree from vertical angle of the slotted hole; loading the armor steel plate member into the press, on to the jig; closing the press so that the outer cutting surface of the plurality of punches at least partially engages the armor steel plate member at the angled through holes; closing the press further so that the plurality of punches passes through the armor steel plate member and at least partially into the die, piercing the slotted hole; opening the press to that the plurality of punches retracts from the dies and the armor steel plate member; and heat treating the armor steel plate member until a Brinell of about 325 or more is achieved, piercing the armor steel plate member with a plurality of 20 to 30 degree from vertical slotted holes.

The invention of the third aspect may be further characterized by one or any combination of the features described herein, such as including the step of re-punching the plurality of slotted hole with at least a 5% larger punches and 5% larger dies; the steel comprises at least 0.6% Cr, 0.6% Mo, 0.15% C, 0.2% Mn, 0.05% Si, and at most 0.05% P, 0.06% S, all by weight.

It should be appreciated that the above referenced aspects and examples are non-limiting, as others exist within the present invention, as shown and described herein.

### DESCRIPTION OF THE DRAWINGS

FIG. 1 is a perspective view of one illustrative example of a plate member with slotted holes according to the teachings of this invention.

FIG. 2 is a perspective view of one illustrative example of a plate member with holes according to the teachings of this invention.

FIG. 3 is a side view of a punch and die in a press according to the teachings of this invention.

FIG. 4 is a detailed perspective view of a illustrative punch according to the teachings of this invention.

FIG. 5 is a detailed perspective view of a illustrative die according to the teachings of this invention.

### DETAILED DESCRIPTION OF THE PREFERRED EMBODIMENT

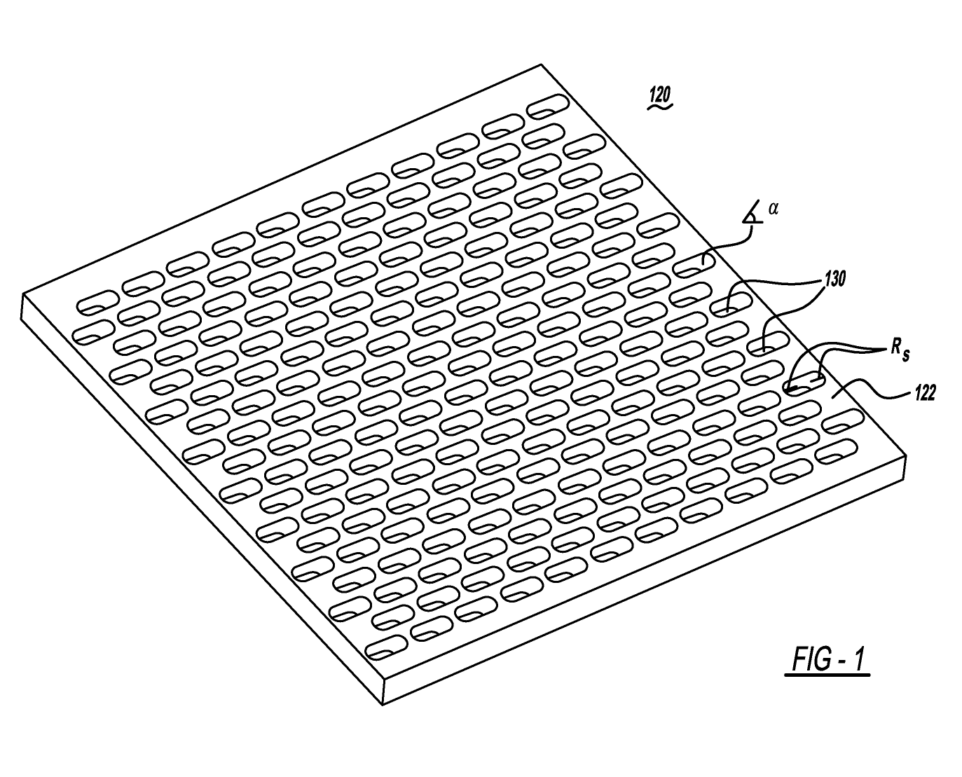

The present invention is a method of removing material from thick plate materials, more particularly to a method of piercing acutely angled through holes in high strength steel plates. One preferred embodiment discussed therein is illustrated in FIG. 1. It is also contemplated that the below detailed inventive method may be utilized to more efficiently create blanks or in other trimming operations.

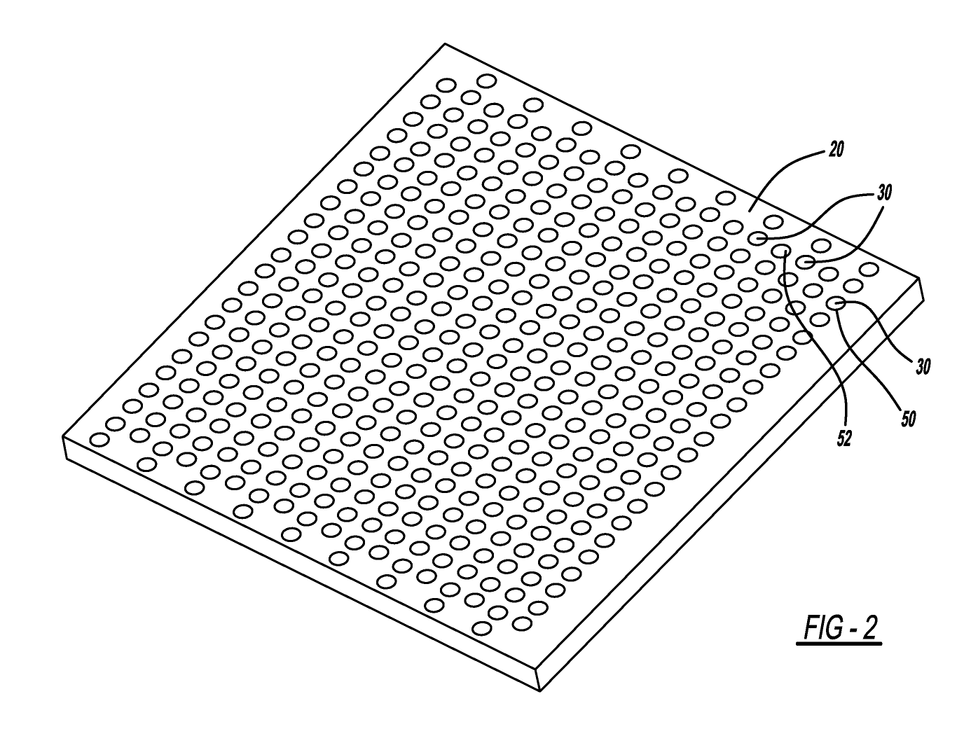

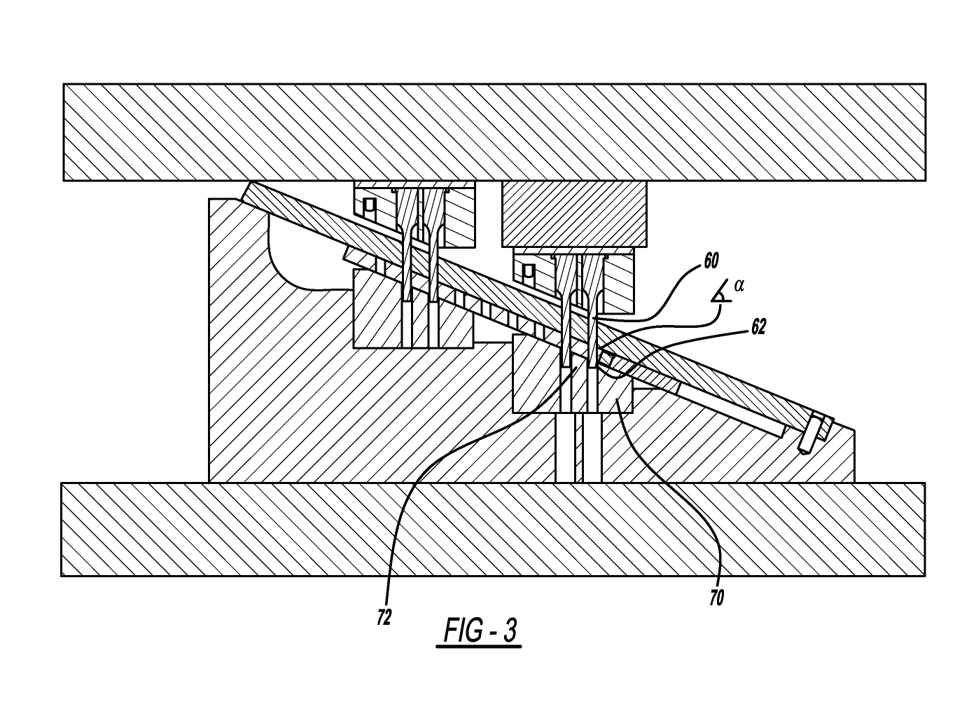

Referring to FIG. 2, in a first aspect, the present invention contemplates a method of piercing a hole 30 through a plate member 20 including the at least some of the following steps. Providing the plate member 20 which the hole 30 will ultimately be formed into. It is contemplated that this method may be applicable wherein the plate member 20 could be any ridged material (e.g. metals, plastics, composites or any combination thereof). Removing at least 10% or more of a hole offal material of the plate member in at least one edge portion 50 of the hole 30, preferably removing at least 20% or more, and most preferably removing 50% or more. It is contemplated that the material to be removed (hole offal material) may be in an area that is not at the one edge portion 50 of the hole 30, but at some distance away, possibly as far as the center of the hole 30. Preferably, the material removed is at least partially congruent to the one edge portion 50.

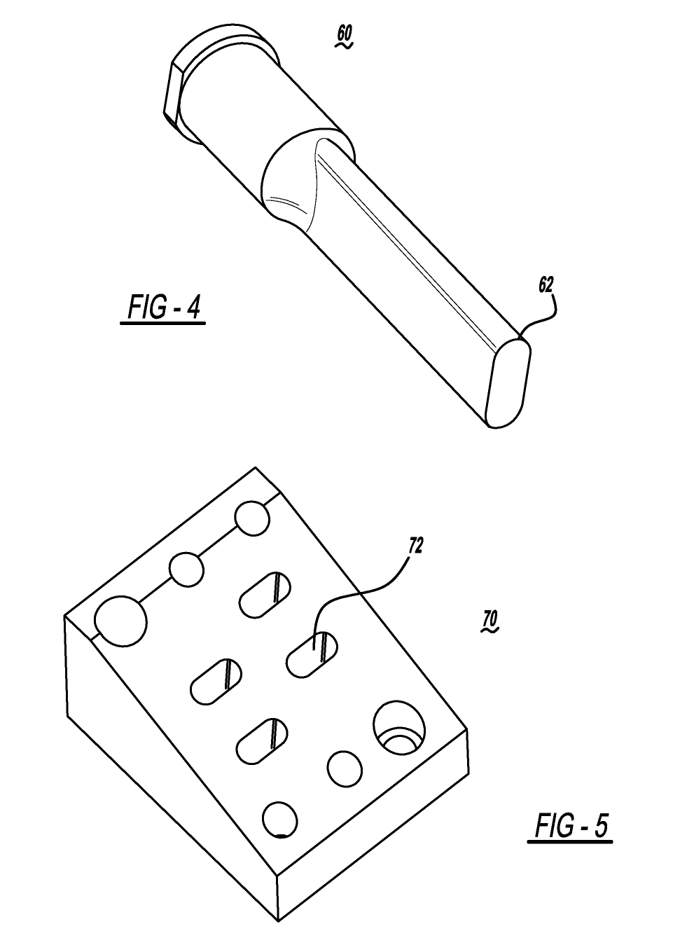

Providing a punch 60 which has an outer cutting surface 62 with a punch profile equivalent to profile of the hole 30. Providing a die 70 (e.g. piercing die) which has an open inner surface 72 with a die inner surface profile at least about 1% greater than the punch profile, preferably at least about 3% more, and most preferably at least about 5% to 15%. Preferably, both the punch and die are constructed from hardened tool steel (or alloy) commonly available and known within the art. An exemplary punch and die are shown in FIGS. 4 and 5, respectively.

Providing a press that holds and moves the punch 60, the die 70, or both in an opening and closing motion. It is contemplated that this press could be mechanical, hydraulic, or pneumatic in nature, so long as it can create the necessary pressures (tonnage) to drive the punch through the plate material and into the die. Preferably, the press will require less tonnage (e.g. about 50% less or more) than if the step of removing the hole offal material had not occurred.

Closing the press so that the outer cutting surface 62 of the punch 60 may at least partially engage the plate member 20 where the at least 10% hole offal material has been removed. Preferably, the outer cutting surface 62 engages the plate member at or immediately adjacent to (e.g. within about 0.5 mm) an outer vertical surface 52 of the edge portion 50. Most preferably, the outer cutting surface may be at least partially coextensive with the outer vertical surface 52 of the edge portion 50.

Finally, closing the press further so that the punch 60 passes through the material of the plate member 20 and at least partially into the die 70, piercing the hole 30; and opening the press to that punch 60 retracts from the die 70 and the material.

Referring to FIG. 1, in a second aspect, a method of piercing a slotted hole 130 at an acute angle (α) through a plate member 120 is contemplated. The method is similar to that of the first aspect and for the sake of brevity; the common steps are not repeated in this text.

In this aspect, a through-hole (not shown) may be machined (e.g. via a mill, drill, laser, water-jet, or like hole cutting techniques) at or within about 5° of the acute angle (α) through the plate member 120 at or near (e.g. within about 5-10 mm) each end of the slotted hole 130. It is contemplated that the through holes may have a radius (R_{T}) equivalent to that of the radius (R_{S}) at the ends of the slotted hole 130 or may be up to about 50% smaller. Preferably, the radii (R_{T}), (R_{S}) have a value within 30% of each other, more preferably within about 20%, and most preferably within 10%.

Additionally, it is contemplated that a jig may be provided a jig that holds the plate member 120 at or near the acute angle (α) of the slotted hole 130. This jig may help provide the proper orientation for the plate.

Closing the press so that the outer cutting surface 62 of the punch 60 may at least partially engages the plate member 120 where the through-holes are located. Preferably, the outer cutting surface 62 engages the plate member at or immediately adjacent to (e.g. within about 0.5 mm) an outer vertical surface 152 of the through-hole. Most preferably, the outer cutting surface may be at least partially coextensive with the outer vertical surface 52 of the through-hole.

In one preferred embodiment, the acute angle (α) can be between about 15 and 30 degrees from vertical relative to a planer surface 122 of the plate member 120, more preferably the angle can be between about 20 and 30 degrees, and most preferably between about 20 and 25 degrees. Additionally, the plate member 120 is constructed of steel (or alloy of steel) with a thickness of between 5 mm and 25 mm. Furthermore, the steel alloy may include at least 0.6% Cr, 0.6% Mo, 0.15% C, 0.2% Mn, 0.05% Si, and at most 0.05% P, 0.06% S, all by weight. One preferred steel commercially available is known as 4130 grade high strength steel.

In another preferred embodiment the method of the either the first or second aspect of the present invention, further may include the step of softening the material (e.g. steel or alloy) to a Brinell hardness (“BHN”) below 210 prior to the closing step. In a more preferred embodiment, the BHN is less than about 195, and most preferably below about 180. Also it may further include the step of hardening the material to a Brinell above about 325 after the hole (slotted or otherwise) is formed. In a more preferred embodiment, the final BHN is more than about 340, and most preferably above about 350. These BHN numbers assume a plate of about 0.625 inches (15.9 mm) thick, although thinner or thicker plates are contemplated.

Optionally, the softening step may include annealing the steel by heating and/or the hardening step may include heat treating the plate member with an oil quench method, water quench method, or both. As one possible illustrative example, to achieve a BHN of about 200 or less (softening), the steel may be heated to about 1550° F., held for 60 min/in of stack, furnace cool at 20° F. to 1200° F. (−6 to 650° C.), and air cooled. Another example, to achieve a BHN of about 325 or more (hardening), the steel can be heated to about 1650° F. (900° C.), holding the temperature for about 60 minutes per inch of steel, water quenching aggressively, then tempering by heating to about 950° F. (510° C.) for about 45 minutes per inch of steel and allowing to air cool.

It is well known in the industry that Brinell hardness is determined by forcing a hard steel or carbide sphere of a specified diameter under a specified load into the surface of a material and measuring the diameter of the indentation left after the test. The Brinell hardness number, or simply the Brinell number, is obtained by dividing the load used, in kilograms, by the actual surface area of the indentation, in square millimeters. The result is a pressure measurement, but the units are rarely stated. ASTM E-10 is a standard test for determining the Brinell hardness of metallic materials.

It is also contemplated that both aspect of the invention may include the step of re-punching the hole with at least a 5% larger punch and 5% larger die.

In the most preferred embodiment, the method according to the second aspect described above is utilized to manufacture armor steel plating for use in military vehicles or any other armoring application. In this embodiment, a plurality of slotted holes 130 are formed across the face of the plate 120. These holes 130 have an angle (α) of between about 15 to 30 degree from vertical relative to the face of the plate 120, more preferably between about 20 and 30 degrees, and most preferably between about 20 and 25 degrees. Additionally, the plate 120 is annealed (resulting in a hardness of about 210 Brinell or below, preferably about 180 or below) prior to punching and hardened afterwards (resulting in a hardness of about 325 Brinell or above, preferably with a BHN of 350 to 375). It is contemplated that this armor plate may range in thickness from about 5 mm to about 30 mm in thickness or more.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes.

The term “consisting essentially of” to describe a combination shall include the elements, ingredients, components or steps identified, and such other elements ingredients, components or steps that do not materially affect the basic and novel characteristics of the combination.

The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

What is claimed is:

1. A method of piercing a hole through a plate member, comprising the steps of:
a. providing the plate member;
b. removing at least 10% of a hole offal material of the plate member in at least one edge portion of the hole;
c. providing a punch which has a outer cutting surface with a punch profile equivalent to profile of the hole;
d. providing a die which has an open inner surface with a die inner surface profile at least 1% greater than the punch profile;
e. providing a press that holds and moves the punch, the die, or both in an opening and closing motion;
f. closing the press so that the outer cutting surface of the punch at least partially engages the plate member where the at least 10% hole offal material has been removed;
g. closing the press further so that the punch passes through the material of the plate member and at least partially into the die, piercing the hole; and
h. opening the press to that punch retracts from the die and the material.

2. A method of piercing a slotted hole at an acute angle through a plate member, comprising the steps of:
a. providing the plate member;
b. machining an angled through hole through the plate member at each end of the slotted hole;
c. providing a punch which has a outer cutting surface with a punch profile equivalent to profile of the slotted hole;
d. providing a die which has an open inner surface with a die profile at least 1% greater than the punch profile;
e. providing a press that holds and moves the punch, the die, or both in an opening an closing motion;
f. providing a jig that holds the plate member at the acute angle of the slotted hole;
g. loading the plate member into the press, on to the jig;
h. closing the press so that the outer cutting surface of the punch at least partially engages the plate member at the angled through holes;
i. closing the press further so that the punch passes through the plate member and at least partially into the die, piercing the slotted hole; and
j. opening the press to that punch retracts from the die and the plate member.

3. The method according to claim 2, wherein the acute angle is between 20 and 30 degrees from vertical relative to a planer surface of the plate member.

4. The method according to claim 3, wherein the plate member is comprised of a steel with a thickness of between 5 mm and 25 mm.

5. The method according to claim 3, further including the step of softening the steel to a Brinell hardness below 210 prior to the closing steps.

6. The method according to claim 5, further including the step of hardening the steel to a Brinell above 325 or more after the slotted hole is formed.

7. The method according to claim 5, wherein the softening step includes annealing the steel by heating.

8. The method according to claim 6, wherein the hardening step includes heat treating the plate member with a oil quench method, water quench method, or both.

9. The method according to claim 2, including the step of re-punching the slotted hole with at least a 5% larger punch and 5% larger die.

10. The method according to claim 4, wherein the steel comprises at least 0.6% Cr, 0.6% Mo, 0.15% C, 0.2% Mn, 0.05% Si, and at most 0.05% P, 0.06% S, all by weight.

11. A method of piercing an armor steel plate member with a plurality of 20 to 30 degree from vertical slotted holes, comprising the steps of:
a. providing the armor steel plate member;
b. annealing the armor steel plate member by application of heat until a Brinell of less than 210 is achieved;
c. machining a plurality of through holes at 20 to 30 degree from vertical the through the armor steel plate member at each end of the slotted hole;
d. providing a plurality of punches which has a outer cutting surface with a punch profile equivalent to profile of the slotted hole;
e. providing a plurality of dies which has an open inner surface with a die profile at least 1% greater than the punch profile;
f. providing a press that holds and moves the punch, the die, or both in an opening an closing motion;
h. providing a jig that holds the armor steel plate member at the 20 to 30 degree from vertical angle of the slotted hole;
i. loading the armor steel plate member into the press, on to the jig;
j. closing the press so that the outer cutting surface of the plurality of punches at least partially engages the armor steel plate member at the angled through holes;
k. closing the press further so that the plurality of punches passes through the armor steel plate member and at least partially into the die, piercing the slotted hole;
l. opening the press to that the plurality of punches retracts from the dies and the armor steel plate member; and
m. heat treating the armor steel plate member until a Brinell of 325 or above is achieved, piercing the armor steel plate member with a plurality of 20 to 30 degree from vertical slotted holes.

12. The method according to claim 11, including the step of re-punching the plurality of slotted hole with at least a 5% larger punches and 5% larger dies.

13. The method according to claim 11, wherein the steel comprises at least 0.6% Cr, 0.6% Mo, 0.15% C, 0.2% Mn, 0.05% Si, and at most 0.05% P, 0.06% S, all by weight.
